(19) United States
(12) Patent Application Publication
(10) Pub. No.: US 2011/0315413 A1
(43) Pub. Date: Dec. 29, 2011

(54) Kit-Of Parts for Multi-Functional Tool, Drive Unit, and Operating Members

(75) Inventors: Adam FISHER, Cooper City, FL (US); Brian SCHMITZ, Fort Lauderdale, FL (US)

(73) Assignee: MAKO Surgical Corp.

(21) Appl. No.: 12/824,131

(22) Filed: Jun. 25, 2010

(51) Int. Cl. B25F 3/00; B25F 5/00

(52) U.S. Cl. 173/1; 173/47; 173/213; 279/144

(57) ABSTRACT

A multi-functional tool is provided including a drive unit and one or more operating members. Each operating member includes a plurality of coupling features configured to be coupled with a plurality of drive unit coupling features. The interaction between the drive unit coupling features and the coupling features of the operating member determines the type of planar motion in which the operating member moves relative to the drive unit when the multi-functional tool is in operation. This motion may be orbital, sagittal, or reciprocal. The motion provided by the drive unit to an operating member may be changed by replacing one operating member coupled to the drive unit with another, different operating member. In some exemplary embodiments, at least three operating member are provided and each operating member is configured to be moved with one of orbital, sagittal, or reciprocal motion.

### BACKGROUND

The present disclosure relates generally to the field of multi-functional tools. More particularly, multi-functional tools that provide for utilization of one or more motions to perform and/or facilitate a task or set of tasks.

Many multi-functional tools, especially those used for surgical procedures, require separate hand pieces for each desired type of tool motion. Others require different hand piece attachments in order to change from one type of motion to another type of motion. Changing hand pieces and/or switching out attachments can require valuable time. For example, in surgical robotic applications, the hand piece is preferably rigidly attached to the end of the robotic arm, so changing hand pieces consumes valuable operating room time and introduces potential position error in the cutting due to the need to change hand pieces. Further, these hand pieces and attachments are often expensive, requiring a significant investment in the multi-functional tool in order to utilize all possible motions/functions.

In many fields (e.g., surgical robotics for orthopedic applications, construction, etc.), it is desirable to utilize different planar motions—orbital, sagittal, and reciprocal—to execute a given task or set of tasks (e.g., a surgical procedure). For many multi-functional tools, fewer than all three of these three motions can be provided.

It would be desirable to have a multi-functional tool that allows a single planar cutting hand piece/driver to provide orbital, sagittal, and reciprocating motions. It would be further desirable if changes in the motion provided by the hand piece/driver could be accomplished by simply changing (e.g., switching, interchanging, swapping out, replacing, etc.) an operating member used therewith.

### SUMMARY

One embodiment of the invention relates to a kit-of-parts for a multi-functional tool. The kit-of-parts comprises a drive unit with a first mounting pin, a second mounting pin movable relative to the first mounting pin, and a first operating member having a first arrangement of first and second apertures. The first and second apertures are configured to engage the first and second pins, respectively, when the first operating member is connected to the drive unit. Further, the first arrangement is configured to cause the first operating member to move in a first motion relative to the drive unit when the second mounting pin is moved relative to the first mounting pin. The kit-of-parts further comprises a second operating member having a second arrangement of first and second apertures different from the first arrangement. The first and second apertures are configured to engage the first and second pins, respectively, when the second operating member is connected to the drive unit. Further, the second arrangement is configured to cause the second operating member to move in a second motion relative to the drive unit when the second mounting pin is moved relative to the first mounting pin.

Another embodiment of the invention relates to a method for changing the motion of a multi-functional tool. The method comprises connecting a first operating member having a first arrangement of first and second apertures to a drive unit having a first mounting pin and a second mounting pin by engaging the first and second apertures with the first and second mounting pins, respectively; moving the second mounting pin relative to the first mounting pin to cause the first operating member to move in a first motion relative to the drive unit; removing the first operating member from the drive unit; connecting a second operating member having a second arrangement of first and second apertures, different from the first arrangement, to the drive unit by engaging the first and second apertures with the first and second mounting pins, respectively; and moving the second mounting pin relative to the first mounting pin to cause the second operating member to move in a second motion relative to the drive unit.

Another embodiment of the invention relates to a drive unit providing adjustable stroke distances for a work-engaging portion of an operating member. The drive unit comprises a drive shaft rotatable about a drive shaft axis; a motor configured to drive the drive shaft; a first drive unit coupling feature defining a first axis; a second drive unit coupling feature defining a second axis and being configured to be driven in an orbital path about the drive shaft axis upon rotation of the drive shaft; and an offset mechanism configured to change the orbital path of the second drive unit coupling feature about the drive shaft axis and thereby change a stroke distance of a work-engaging portion of an operating member coupled to the first drive unit coupling feature and the second drive unit coupling feature.

Another embodiment of the invention relates to a sagittal-movement operating member removably coupleable to a drive unit. The sagittal-movement operating member comprises an elongated body extending substantially along a longitudinal axis and including a front portion opposite a rear portion along the longitudinal axis; a first coupling feature disposed between the front portion and the rear portion of the elongated body and configured to engage a corresponding first drive unit coupling feature to substantially prevent movement of the elongated body relative to the first drive unit coupling feature along and transverse to the longitudinal axis at the first coupling feature; and a second coupling feature disposed between the front portion and the rear portion of the elongated body and closer to the rear portion of the elongated body relative to the first coupling feature, the second coupling feature being configured to engage a corresponding second drive unit coupling feature to allow movement of the second drive unit coupling feature relative to the elongated body one of along and parallel to the longitudinal axis without causing substantial movement of the second drive unit coupling feature relative to the elongated body transverse to the longitudinal axis at the second coupling feature.

Another embodiment of the invention relates to a reciprocating-movement operating member removably coupleable to a drive unit. The reciprocating-movement operating member comprises an elongated body extending substantially along a longitudinal axis and including a front portion opposite a rear portion along the longitudinal axis; a first coupling feature being disposed between the front portion and the rear portion of the elongated body and configured to engage a corresponding first drive unit coupling feature to allow movement of the elongated body relative to the first drive unit coupling feature one of along or parallel to the longitudinal axis while substantially preventing movement transverse to the longitudinal axis at the first coupling feature; and a second coupling feature being disposed between the front portion and the rear portion of the elongated body and closer to the rear portion of the elongated body relative to the first coupling feature, the second coupling feature being configured to engage a corresponding second drive unit coupling feature to allow movement of the second drive unit coupling feature relative to the elongated body transverse to the longitudinal axis without causing substantial movement of the second drive unit coupling feature relative to the elongated body along or parallel to the longitudinal axis at the second coupling feature.

### BRIEF DESCRIPTION OF THE DRAWINGS

The accompanying drawings, which are incorporated and constitute a part of this specification, illustrate embodiments of the invention and together with the description serve to explain aspects of the invention.

FIG. 1 is a perspective view of a drive unit of a multi-functional tool according to an exemplary embodiment.

FIG. 2 is a partially exploded view of the multi-functional tool of FIG. 1 including a drive shaft, a motion transfer system, and a motor.

FIG. 3 is a partial perspective view of the multi-functional tool of FIG. 1 with a cover in the open position.

FIG. 4 is a partial perspective view of the multi-functional tool of FIG. 1 with the cover in a closed position.

FIG. 5a is a top plan view of the drive unit of the multi-functional tool of FIG. 1 showing a second mounting pin having a first offset.

FIG. 5b is a top plan view of the drive unit of the multi-functional tool of FIG. 1 showing the second mounting pin having a second offset.

FIG. 6 is a top plan view of the multi-functional tool of FIG. 1 having an orbital-movement operating member removably coupled to the drive unit.

FIG. 7 is a top plan view of the multi-functional tool of FIG. 1 having a sagittal-movement operating member removably coupled to the drive unit.

FIG. 8 is a top plan view of the multi-functional tool of FIG. 1 having a reciprocating-movement operating member removably coupled to the drive unit.

FIG. 9 is a top plan view of the multi-functional tool of FIG. 1 having another exemplary embodiment of an orbital-movement operating member removably coupled to the drive unit.

### DETAILED DESCRIPTION

Referring to the FIGURES, a multi-functional tool is disclosed. The multi-functional tool is configured to achieve different, preferably planar movements by interchanging operating members coupleable to a drive unit. That is, an operator may select the motion of the multi-functional tool by changing (e.g., switching, interchanging, swapping out, replacing, etc.) the operating member (e.g., removing one operating member and replacing it with another operating member). In this way, the multi-functional tool eliminates the need for a user to change hand pieces in order to achieve a different planar motion. Further, the multi-functional tool also eliminates the need for separate drivers or hand piece attachments. Other benefits of this configuration include, but, are not limited to, improved efficiency, cost savings, and minimizing complications associated with switching out drivers and/or hand pieces in order to change an operating motion to a tool.

The multi-functional tool may be used by itself (e.g., in a hand-held manner). Alternatively, the multi-functional tool may be used in combination with a support structure. For example, the multi-functional tool may be coupled to a robotic arm used during a surgical procedure. It should be noted that while the multi-functional tool is frequently discussed in this disclosure in reference to use for surgical procedures, the multi-functional tool may be utilized for any number of tasks (e.g., construction, finish carpentry, etc.).

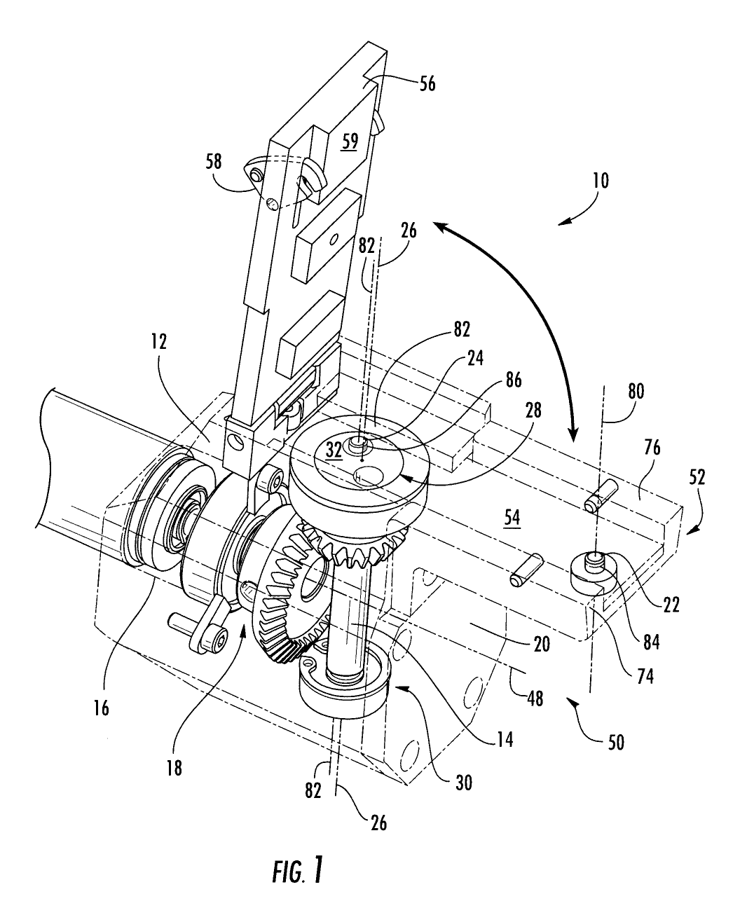

Referring to FIG. 1, a multi-functional tool 10 configured to provide, for example, orbital, sagittal, and reciprocal motion is shown according to an exemplary embodiment. An operator may select the motion of the multi-functional tool 10 by changing the operating member (see e.g., FIGS. 6-9 illustrating exemplary operating members 100, 200, 300, and 400).

The multi-functional tool 10 includes a drive unit 12 according to an exemplary embodiment. The drive unit 12 provides motion to an operating member engaged therewith. The drive unit 12 is shown configured to provide orbital, sagittal, and reciprocal motion to an operating member, the motion provided to the operating member being substantially dependent on the interaction between the drive system and one or more coupling features of the operating member, as will be discussed in more detail below. Stated otherwise, the same drive unit 12 is utilized to provide for each type of planar motion (orbital, sagittal, and reciprocal motion).

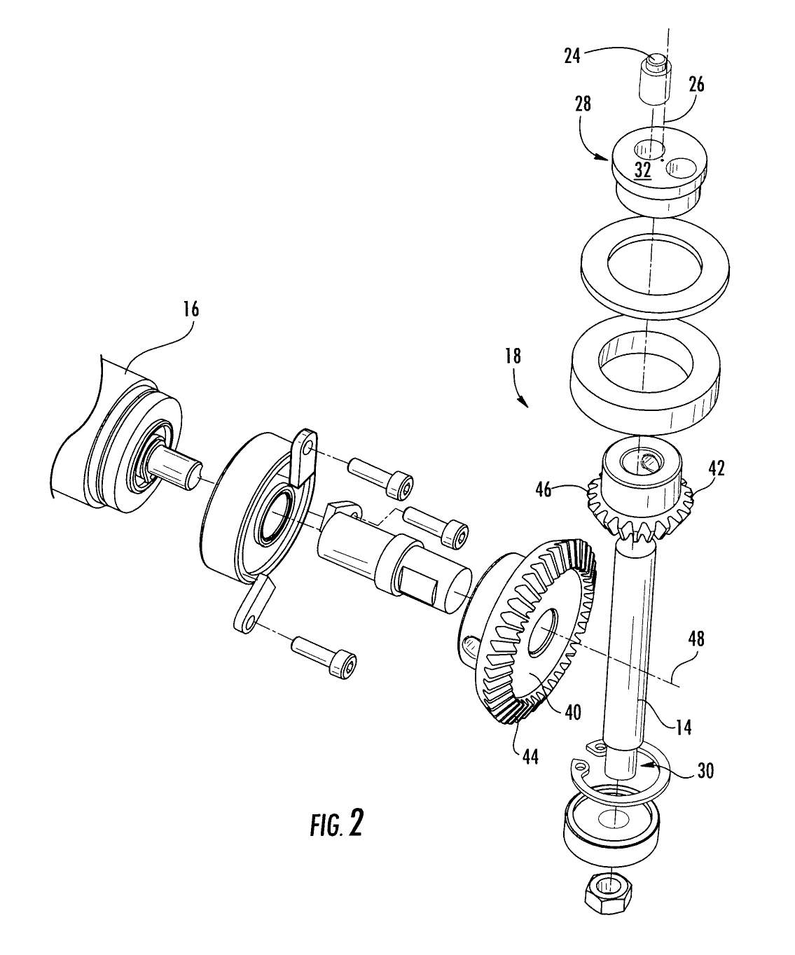

Referring to FIGS. 1-2, the drive unit 12 includes a drive shaft 14 operably driven by a motor 16, a motion transfer system, shown as a gear system 18, configured to transfer motion from the motor 16 to the drive shaft 14, a housing 20, and a pair of drive unit coupling features, shown including a first mounting pin 22 and a second mounting pin 24, respectively, according to an exemplary embodiment.

Referring further to FIGS. 1-2, the drive shaft 14 is shown generally elongated along a drive shaft axis 26 according to an exemplary embodiment. The drive shaft 14 is configured to provide motion to at least one of the drive unit coupling features. The drive shaft 14 includes a first end 28 generally opposite a second end 30. The at least one drive unit coupling feature is shown coupled to the first end 28 of the drive shaft 14. The second end 30 of the drive shaft 14 is shown rotatably coupled to the housing 20.

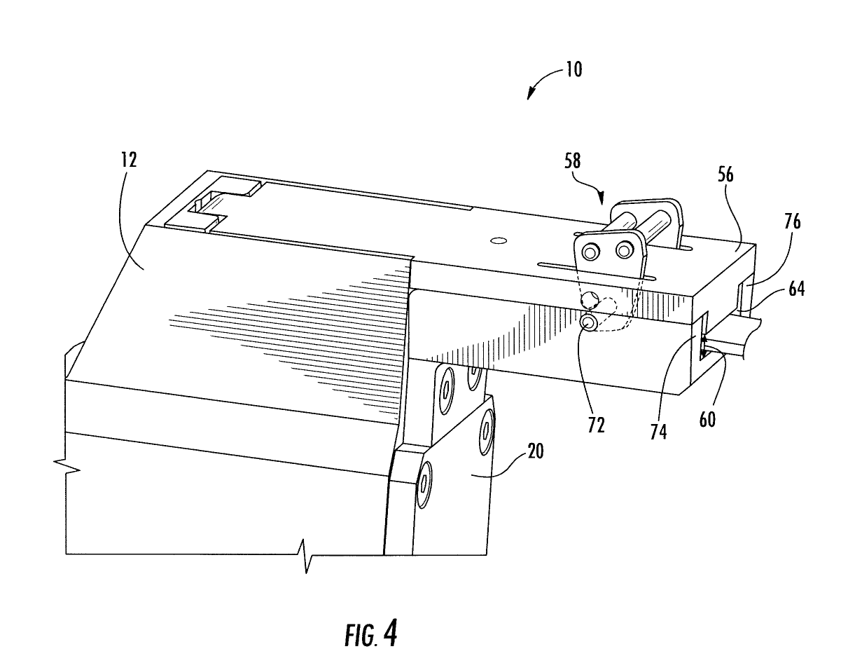

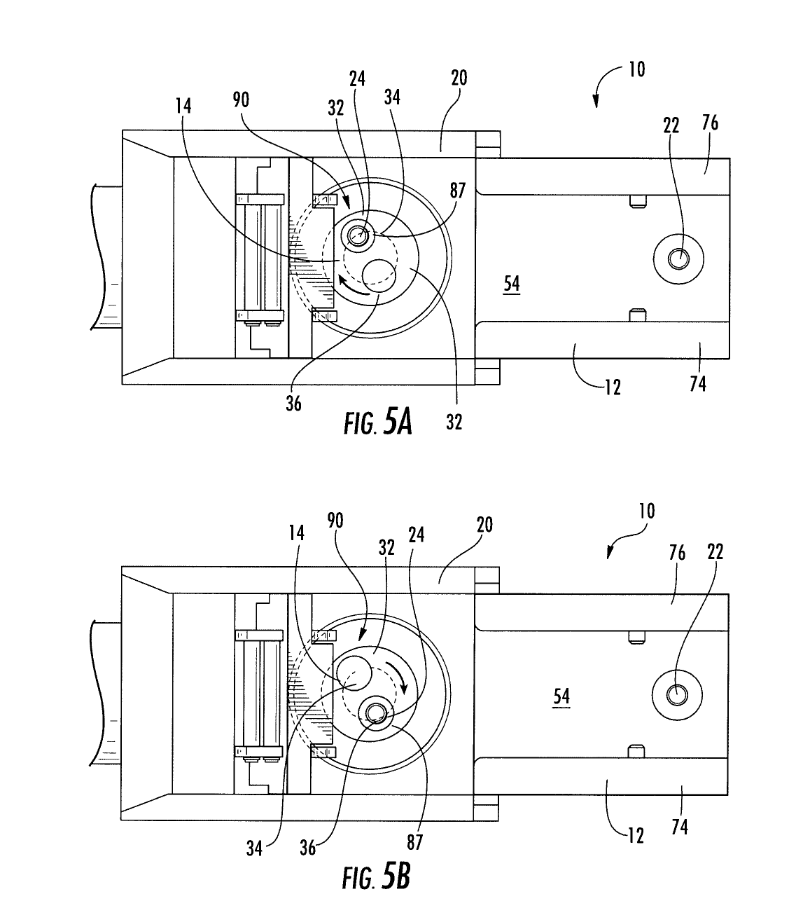

In the exemplary embodiment shown, the first end 28 of the drive shaft 14 includes a first surface 32. The first surface 32 defines a plane substantially perpendicular to the drive shaft axis 26. As will be discussed in more detail later, a plurality of bores, shown a first bore 34 and a second bore 36 (see FIGS. 5A and 5B), are provided at the first end 28 of the drive shaft 14 to removably receive one of the drive unit coupling features. The bores 34,36 are shown extending generally from the first surface 32 at the first end 28 of the drive shaft 14 a distance toward the second end 30 of the drive shaft 14 in a direction generally parallel to the drive shaft axis 26. Generally, the size and shape of the bores corresponds to the size and shape of the drive unit coupling features to be received therein or a portion thereof.

FIGS. 1-2 show the motor 16 operably coupled to the drive shaft 14 by the gear system 18 according to an exemplary embodiment. The motor 16 is configured to operably drive the drive shaft 14, causing the drive shaft 14 to rotate about the drive shaft axis 26. The motor 16 may be any motor suitable for causing the drive shaft 14 to rotate about the drive shaft axis 26 and having characteristics suitable for the desired application.

FIGS. 1-2 also show the gear system 18 including a first beveled gear 40 and a second beveled gear 42 according to an exemplary embodiment. The gear system 18 is configured to transfer motion from the motor 16 to the drive shaft 14. The first beveled gear 40 is shown coupled to the motor 16. The second beveled gear 42 is shown coupled to and co-axial with the drive shaft 14. In operation, the motor 16 causes the first beveled gear 40 to rotate. A plurality of gear teeth 44 of the first beveled gear 40 are meshed with a plurality of gear teeth 46 of the second beveled gear 42. Accordingly, rotation of the first beveled gear 40 causes the second beveled gear 42 to rotate, and, thereby, the drive shaft 14 to rotate. In the exemplary embodiment shown, an axis of rotation 48 of the first beveled gear 40 is substantially perpendicular to the drive shaft axis 26, though other configurations suitable for transferring motion from the motor to the drive shaft are contemplated. For example, a gear system may include more than two gears. Further still, motion transferring elements other than gears may be utilized.

Further referring to FIGS. 1-2, the housing 20 includes a body portion 50 and an operating member receiving portion 52 according to an exemplary embodiment.

The body portion 50 of the housing 20 provides support for a number of the components of the drive unit 12, including, but not limited to, the drive shaft 14 and the motor 16. The body portion 50 may have any number of configurations suitable for providing support for components of the drive unit 12. For example, the size and/or shape of the body portion may be varied to accommodate different combinations of components that provide for rotation of the drive shaft.

The operating member receiving portion 52 of the housing 20 includes a support surface 54, a cover 56, and a securing device 58 according to an exemplary embodiment.

The support surface 54 is configured to at least partially support an operating member. The support surface 54 is shown generally planar and partially defined by the first surface 32 of the drive shaft 14, allowing a substantially planar portion of an operating member to be disposed thereon. During operation of the multi-functional tool 10, the operating member is typically slidably moved along the support surface 54 in a plane substantially parallel thereto. In the exemplary embodiment shown, the drive shaft axis 26 is substantially perpendicular to the plane defined by the support surface 54, and, accordingly, to the plane of movement of an operating member engaged with the drive unit 12.

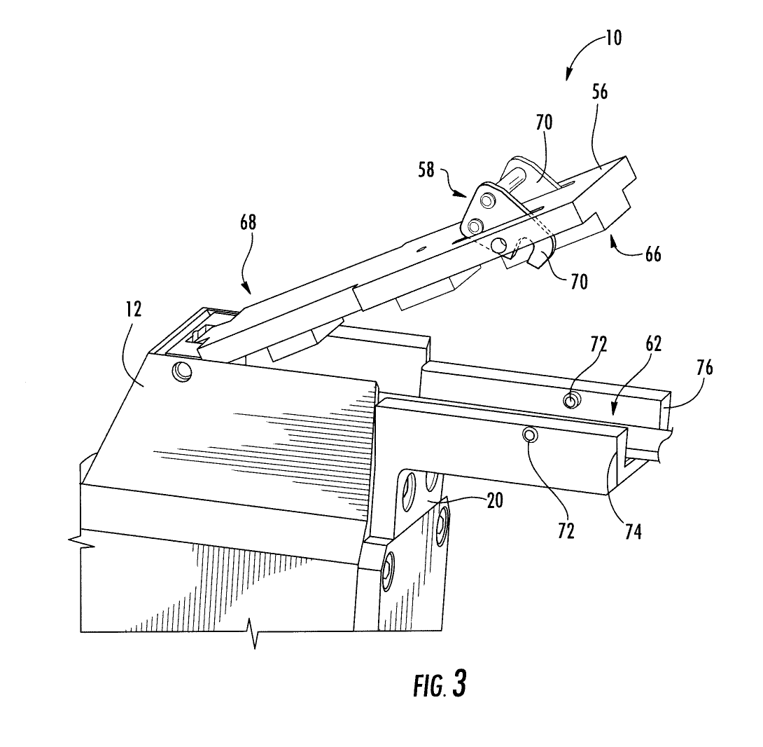

Referring to FIGS. 3-4, the cover 56 (e.g., lid, top, cap, etc.) is configured to at least partially confine a portion of an operating member between the support surface 54 and the cover 56. The cover 56 is pivotally coupled to the housing 20 and movable between a first or open position and a second or closed position. As shown in FIG. 3, in the open position, a first surface 59 of the cover 56 is disposed at an angle to the support surface 54. As shown in FIG. 4, in the closed position, the first surface 59 of the cover 56 is disposed generally parallel to the support surface 54 and an offset 60 exists between the first surface 59 of the cover 56 and the support surface 54. The offset 60 substantially corresponds to a thickness of the portion of an operating member intended to be at least partially confined therebetween but with sufficient clearance for the operating member to move relative to the drive unit 12. In this way, the motion of an operating member in the direction perpendicular to the plane of motion (substantially vertically as shown in FIGS. 3-4) of the operating member is restricted.

With the cover 56 in the closed position, a cavity 62 is formed between the cover 56 and the support surface 54. An opening 64 proximate to a free end 66 of the cover 56 distal to a pivotal end 68 of the cover 56 allows a portion of an operating member to extend out of the cavity 62. In this way, a portion of an operating member may be secured by the drive unit 12 (though, remaining movable within a plane parallel to the support surface 54) and another portion of the operating member may be substantially cantilevered, extending away from the drive unit to engage with an element to be operated (e.g., worked, etc.) on by the multi-functional tool 10.

Referring further to FIGS. 3-4, the securing device 58 is used to maintain the cover 56 in the closed position during operation of the multi-functional tool 10 according to an exemplary embodiment. The securing device 58 includes a pair of hook elements 70 and a pair of projections, shown as pins 72. The hook elements 70 are pivotally coupled to the cover 56 and coupled to each other. Coupling the hook elements 70 to each other helps the hook elements 70 to move substantially in parallel, facilitating the securing and releasing functions of the securing device 58. The pins 72 extend toward each other from a pair of opposing side walls, shown as a first side wall 74 and a second side wall 76, located substantially to either side of the support surface 54. As the cover 56 is moved from the open position to the closed position, the hook elements 70 substantially automatically catch on the pins 72 and pivot in a first direction relative to the cover 56 to secure (e.g., maintain, retain, etc.) the cover 56 in the closed position. To release the cover 56, an operator may rotate the hook elements 70 in a second direction, generally opposite the first direction, relative to the cover 56; the cover 56 can then be moved from the closed position to the open position. In some exemplary embodiments, the cover 56 is biased towards the open position and will move from the closed position toward the open position once the securing device 58 is released. It should be noted that the securing device 58 allows a user to quickly secure and release the cover 56 relative to the housing. While not required, this aspect of the securing device 58 may be particularly beneficial during operation of the multi-functional tool 10. For example, the quick-secure/quick-release capabilities of the securing device 58 may help save time during a time-sensitive surgical procedure. According to other exemplary embodiments, any device suitable for securing the cover relative to the housing and/or releasing the cover from the housing may be used (e.g., other quick-release devices, a push-to-open device, snapping devices, threaded fasteners, magnetically-operable devices, etc.).

According to an alternative embodiment, features other than a cover and securing device may be used to maintain an operating member in a desired position during operation of the multi-functional tool 10. For example, tethers, clips, or elements that provide for vertical restraint may be used to constrain the motion of an operating member in a direction substantially perpendicular to the support surface 54.

Referring to FIGS. 1 and 5a-5b, the first mounting pin 22 and the second mounting pin 24 are configured to help couple an operating member to the drive unit 12 according to an exemplary embodiment. The first mounting pin 22 extends a distance away from the support surface 54 and defines a first axis 80. Similarly, the second mounting pin 24 extends a distance away from the support surface 54 and defines a second axis 82. The first mounting pin 22 and the second mounting pin 24 are spaced a distance apart and coupled with corresponding coupling features of the operating members (shown, for example, as apertures in FIGS. 6-9, which illustrate various operating members engaged by the pins 22, 24).

Referring generally to the FIGURES, the first mounting pin 22 and the second mounting pin 24 are further configured to provide control over the motion provided to the operating member according to an exemplary embodiment. The second mounting pin 24 is configured to be moved relative to the first mounting pin 22 when the multi-functional tool 10 is being operated. For example, the second mounting pin 24 is coupled to the drive shaft 14 and configured to be moved about the drive shaft axis 26. As the drive shaft 14 rotates, the second mounting pin 24 is moved in an orbital path about the drive shaft axis 26. As the second mounting pin 24 is driven by the drive shaft 14, the first mounting pin 22 remains substantially stationary. That is, the location of the first axis 80 is shown fixed relative to the support surface 54. When an operating member is coupled to the first mounting pin 22 and the second mounting pin 24, the movement of the second mounting pin 24 relative to the first mounting pin 22 causes the operating member to move with a sagittal, orbital, or reciprocal motion. That is, the orbital motion of the second mounting pin 24 of the drive unit 12 can be transformed into orbital, sagittal, or reciprocal motion of an operating member. As will be discussed in more detail below, the interaction between the first mounting pin 22, the second mounting pin 24, and the coupling features of a given operating member determines the motion of the operating member in response to movement of the drive unit 12.

According to an exemplary embodiment, one or both of the first mounting pin 22 and the second mounting pin 24 may be rotatable about its respective axis to prevent wear to operating members engaged therewith. In the exemplary embodiment shown, an outer surface 84 of the first mounting pin 22 and an outer surface 86 of the second mounting pin 24 contact the inner surfaces of the apertures of the operating members during operation of the multi-functional tool 10 (see e.g., FIG. 1 showing outer surfaces 84 and 86). This contact may cause the pins 22, 24 and/or the operating members to experience wear, shortening their useful life. By allowing the pins 22, 24 to rotate about their respective axes 80, 82, this wear can be reduced by reducing the friction between the outer surfaces 84, 86 of the pins 22, 24 and the inner surfaces of the apertures of the operating member. One or more bearings, such as needle bearing 87, may be provided to facilitate this rotation of one or both of the pins 22, 24. It should also be noted that other bearings may be included the drive unit 12 as well to facilitate the motions and interactions discussed herein.

FIGS. 5a-5b illustrate an offset mechanism 90 of the drive unit 12. The offset mechanism 90 allows the drive unit 12 to provide adjustable stroke distances for a work-engaging portion of an operating member. The offset mechanism 90 is configured to change the orbital path of the second mounting pin 24 about the drive shaft axis 26. The offset mechanism 90 includes at least a first bore 34 and a second bore 36, each configured to removably receive the second mounting pin 24, which can be moved between the bores 34, 36. The bores 34, 36 are located at different radial distances from the drive shaft axis 26. As shown in FIG. 5a, the first bore 34 provides a first predetermined offset of the second mounting pin 24 relative to the drive shaft axis 26. As shown in FIG. 5b, the second bore 36 provides a second predetermined offset of the second mounting pin 24 relative to the drive shaft axis 26. Because the second mounting pin 24 is moved about the drive shaft axis 26, changing the offset of the second mounting pin 24 from the drive shaft axis 26 changes (i.e., increases or decreases) the size of the orbital path in which the second mounting pin 24 travels during operation of the multi-functional tool 10. Generally, the larger the orbital path, the greater the stroke distance of the work-engaging portion of the operating member. It should also be noted that the stroke distance may be adjusted by increasing or decreasing the length of an operating member.

FIGS. 6-9 show a number of different operating members configured for use with the drive unit 12. It should be noted that these operating members are not intended to provide an exhaustive representation of the various types of operating members that may be used with the multi-functional tool 10.

Each operating member includes a plurality of coupling features configured to be coupled with the drive unit coupling features. The coupling features of the operating members in FIGS. 6-9 are shown as pairs of apertures that are located to form arrangements that substantially correspond to the type of motion with which they are configured to be moved by the drive unit. More specifically, the interaction between the arrangement of apertures of an operating member and the drive unit coupling features determines the planar motion with which the operating member moves relative to the drive unit. As mentioned above, this motion may be, for example, orbital, sagittal, or reciprocal.

FIG. 6 shows an orbital-movement operating member, shown as an orbital blade 100, that is configured to be removably coupleable to the drive unit 12 according to an exemplary embodiment. The orbital blade 100 includes an elongated body 102 substantially defining a longitudinal axis 104. A secured portion 106 of the orbital blade 100 is substantially planar and configured to be received by the drive unit 12 and vertically constrained between the cover 56 and the support surface 54. A work-engaging portion 108 of the orbital blade 100, substantially opposite the secured portion 106, is used to perform and/or facilitate a task (here, cutting) by engaging with an element (external to the multi-functional tool 10) to be operated (e.g., worked, etc.) on by the multi-functional tool 10.

Referring to FIG. 6, an arrangement of coupling features, shown as an arrangement of apertures 110, is located at the secured portion 106 of the orbital blade 100 according to an exemplary embodiment. The arrangement of apertures 110 is configured to cause orbital movement of the orbital blade 100 relative to the drive unit 12 when used with the drive unit 12. The arrangement of apertures 110 is shown including a first aperture, configured as a slot 112 extending in a direction along or parallel to the longitudinal axis 104, and a second aperture, configured as a circular aperture 114. The slot 112 and the circular aperture 114 are spaced along the longitudinal axis 104. The slot 112 is shown disposed between a front portion 116 and a rear portion 118 of the elongated body 102. The circular aperture 114 is also shown disposed between the front portion 116 and the rear portion 118 of the elongated body 102, but is disposed closer to the rear portion 118 of the elongated body 102 than the slot 112. At this location, the circular aperture 114 is distal to the work-engaging portion 108 of the orbital blade 100 relative to the slot 112.

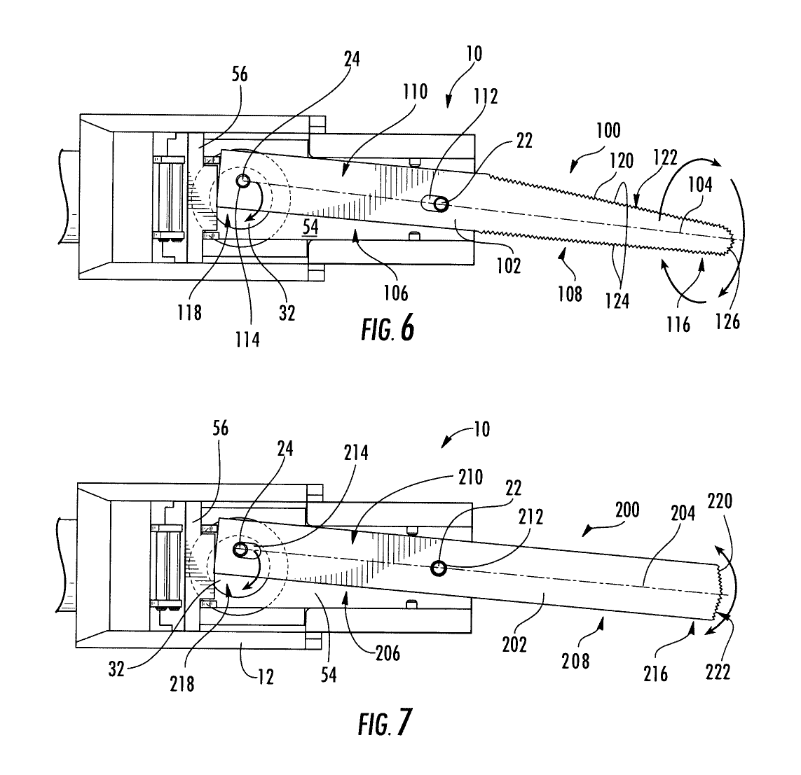

Referring further to FIG. 6, coupling the orbital blade 100 to the drive unit 12 of the multi-functional tool 10 includes engaging the arrangement of apertures 110 with the drive unit coupling features. Preferably the width of the slot 112 is slightly larger than the diameter of the first mounting pin 22 and its length is substantially the same as the longitudinal travel distance of the second mounting pin 24. Preferably the diameter of the circular aperture 114 is slightly larger than the diameter of the second mounting pin 24. The slot 112 is configured to engage the first mounting pin 22 and to allow movement of the elongated body 102 relative to the first mounting pin 22 along or parallel to the longitudinal axis 104 without causing substantial movement of the elongated body 102 relative to the first mounting pin 22 transverse to the longitudinal axis 104. The circular aperture 114 is configured engage the second mounting pin 24 and to prevent movement of the elongated body 102 relative to the second mounting pin 24 along or parallel to and transverse to the longitudinal axis 104 at the circular aperture 114. By its interaction with the circular aperture 114, the orbital motion of the second mounting pin 24 causes the slot 112 of the orbital blade 100 to move linearly relative to the first mounting pin 22 and substantially in a direction along or parallel to the longitudinal axis 104 and can also cause the front portion 116 of the elongated body 102 to pivot about the first mounting pin 22. For example, when the first mounting pin 22 is contacting either end of the slot 112 and the second mounting pin 24 moves orbitally, the front portion 116 of the elongated body 102 can pivot about the first mounting pin 22. That is, as the second mounting pin 24 moves in its orbital path, the front-to-back component of motion of the second mounting pin 24 causes the orbital blade 100 to move generally along or parallel to the longitudinal axis 104 relative to the support surface 54. Further, the circular aperture 114 pivotally moves about the second mounting pin 24 as the second mounting pin 24 is driven. In this way, the interaction between the pins 22, 24 and the arrangement of apertures 110 causes the work-engaging portion 108 of the orbital blade 100 to be moved in a motion relative to the drive unit 12 that is an orbital motion (e.g., circular or elliptical), as generally indicated by the arrows in FIG. 6. It should be noted that while the cover 56 is shown in an open position in FIG. 6 (and FIGS. 7-9), the cover 56 is shown in this position to facilitate discussion of the engagement and operation of the orbital-movement operating member with the drive unit 12. When the multi-functional tool 10 is being operated, the cover 56 is intended to be closed and secured relative to the drive unit 12.

The work-engaging portion 108 of the orbital blade 100 is shown including a plurality of teeth 120 according to an exemplary embodiment. The teeth 120 are configured to cut into and/or through an element (external to the multi-functional tool 10) engaged by the orbital blade 100. The teeth 120 are shown disposed about a perimeter 122 of the work-engaging portion 108, which has a pair of generally tapered sides 124 and a curved end 126. According to other exemplary embodiments, the work-engaging portion of the orbital-movement operating member may be configured to have any structure or shape suitable for utilizing an orbital motion.

According to other exemplary embodiments of an orbital-movement operating member, while the work-engaging portion of the orbital-movement operating member may vary based on the task being performed and/or facilitated, the arrangement of apertures will remain substantially the same. That being said, variations to the individual apertures (e.g., size, length, proximity to the other aperture, etc.) may be made/accommodated so long as the interaction between the arrangement of apertures and the drive unit coupling features still provides for achieving orbital motion. For example, the distance that the slot extends along the longitudinal axis may vary or the apertures may be disposed along a line parallel to the longitudinal axis of the elongated body rather than on the longitudinal axis.

According to an alternative embodiment, one or more of the drive unit coupling features and the coupling features of the orbital-movement operating member may be interchanged (e.g., swapped, switched, etc.) so long as the desired motion of the operating member relative to the drive unit is still achieved. According to one exemplary embodiment, the second drive unit coupling feature is a circular aperture, rather than a pin, and the second coupling feature of the orbital-movement operating member is a pin that is configured to be received in the circular aperture. According to other exemplary embodiments, coupling features other than pins and/or apertures may be utilized.

FIG. 7 shows an sagittal-movement operating member, shown as a sagittal blade 200, that is configured to be removably coupleable to the drive unit 12 according to an exemplary embodiment. The sagittal blade 200 includes an elongated body 202 substantially defining a longitudinal axis 204. A secured portion 206 of the sagittal blade 200 is substantially planar and configured to be received by the drive unit 12 and vertically constrained between the cover 56 and the support surface 54. A work-engaging portion 208 of the sagittal blade 200, substantially opposite the secured portion 206, is used to perform and/or facilitate a task (here, cutting) by engaging with an element to be operated (e.g., worked, etc.) on by the multi-functional tool 10.

Referring to FIG. 7, an arrangement of coupling features, shown as an arrangement of apertures 210, is located at the secured portion 206 of the sagittal blade 200 according to an exemplary embodiment. The arrangement of apertures 210 is configured to cause sagittal movement of the sagittal blade 200 when used with the drive unit 12. The arrangement of apertures 210 is shown including a first aperture, configured as a circular aperture 212, and a second aperture, configured as a slot 214 extending in a direction that is one of along or parallel to the longitudinal axis 204. The circular aperture 212 and the slot 214 are spaced along the longitudinal axis 204. The circular aperture 212 is shown disposed between a front portion 216 and a rear portion 218 of the elongated body 202. The slot 214 is also shown disposed between the front portion 216 and the rear portion 218 of the elongated body 202, but is closer to the rear portion 218 of the elongated body 202 than the circular aperture 212. At this location, the slot 214 is distal to the work-engaging portion 208 of the sagittal blade 200 relative to the circular aperture 212.

Referring further to FIG. 7, coupling the sagittal blade 200 to the drive unit 12 of the multi-functional tool 10 includes coupling the coupling features of the sagittal blade 200 with the drive unit coupling features according to an exemplary embodiment. The circular aperture 212 is configured to engage the first mounting pin 22 and substantially prevent movement of the elongated body 202 relative to the first mounting pin 22 along or parallel to and transverse to the longitudinal axis 204 at the circular aperture 212. The slot 214 is configured engage the second mounting pin 24 and to allow movement of the second mounting pin 24 relative to the elongated body 202 along or parallel to the longitudinal axis 204 without causing substantial movement of the second mounting pin 24 relative to the elongated body 202 transverse to the longitudinal axis 204 at the slot 214. Preferably the diameter of the circular aperture 212 is slightly larger than the diameter of the first mounting pin 22. Preferably the width of the slot 214 is slightly larger than the diameter of the second mounting pin 24 its length is substantially the same as the longitudinal travel distance of the second mounting pin 24.

The motion of the second mounting pin 24 as it moves in its orbital path causes the work-engaging portion 208 to move with sagittal motion relative to the drive unit 12 (e.g., generally pivoting side-to-side). As the second mounting pin 24 is moved, the elongated body 202 is moved side-to-side relative to the support surface 54 at the slot 214, but is prevented from moving front-to-back relative to the support surface 54 because the interaction between the first mounting pin 22 and the circular aperture 212. The elongated body 202 is limited to pivotally moving about the first mounting pin 22 at the circular aperture 212 because the first mounting pin 22 is substantially stationary and the circular aperture 212 is just slightly larger than the first mounting pin 22. Because the first mounting pin 22 is located intermediate the second mounting pin 24 and the work-engaging portion 208, the movement of the second mounting pin 24 toward the first side wall 74 causes the work-engaging portion 208 to move generally toward the second side wall 76 and away from the first side wall 74. Similarly, the movement of the second mounting pin 24 toward the second side wall 76 causes the work-engaging portion 208 to move generally toward the first side wall 74 and away from the second side wall 76. In this way, interaction between the pins 22, 24 of the drive unit 12 and the arrangement of apertures 210 of the sagittal blade 200 causes the work-engaging portion 208 to be moved in a motion relative to the drive unit 12 that is a sagittal motion, as generally indicated by the arrows in FIG. 7.

The work-engaging portion 208 of the sagittal blade 200 is shown including a plurality of teeth 220 along an outer edge 222 according to an exemplary embodiment. The teeth 220 are configured to cut into and/or through a component engaged by the sagittal blade 200. The outer edge 222 of the sagittal blade 200 is shown generally transverse to the longitudinal axis 204; though, according to other exemplary embodiments, the work-engaging portion of the sagittal-movement member may be configured to have any structure or shape suitable for utilizing a sagittal cutting motion.

According to other exemplary embodiments of a sagittal-movement operating member, while the work-engaging portion of the sagittal-movement operating member may vary based on the task being performed and/or facilitated, the arrangement of apertures will remain substantially the same. That being said, variations to the individual apertures (e.g., the size, the length, proximity, etc.) may be made/accommodated so long as the interaction between the arrangement of apertures and the drive unit coupling features still provides for achieving sagittal motion relative to the drive unit. For example, the distance that the slot extends along the longitudinal axis may vary or the apertures may be disposed along a line parallel to the longitudinal axis of the elongated body rather than on the longitudinal axis.

According to an alternative embodiment, one or more of the drive unit coupling features and the coupling features of the sagittal-movement operating member may be interchanged (e.g., swapped, switched, etc.) so long as the desired motion of the operating member is still achieved. According to one exemplary embodiment, the first drive unit coupling feature is a circular aperture, rather than a pin, and the first coupling feature of the sagittal-movement operating member is a pin that is configured to be received in the circular aperture. According to other exemplary embodiments, coupling features other than pins and/or apertures may be utilized.

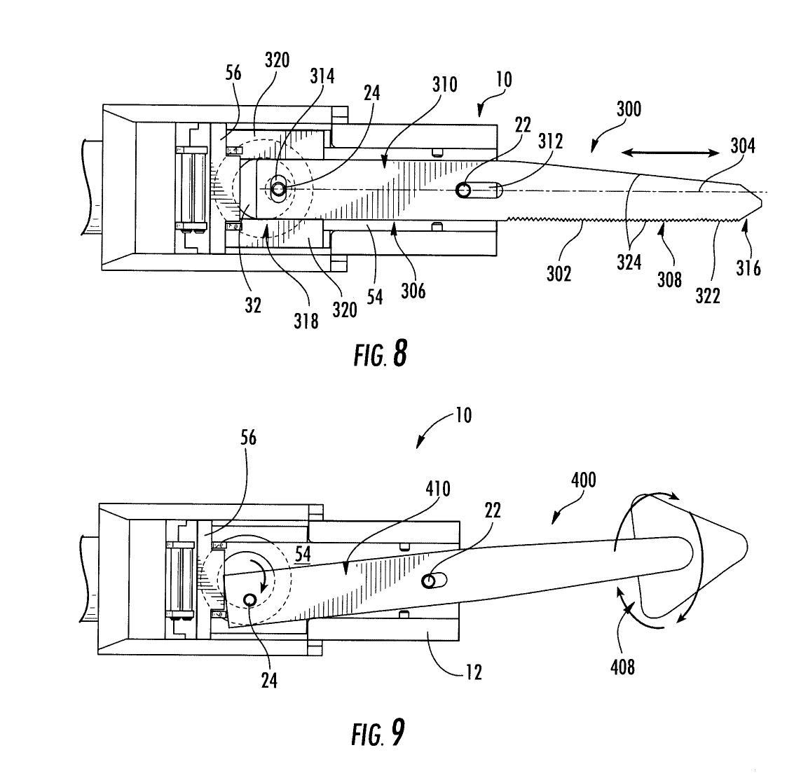

FIG. 8 shows a reciprocating-movement operating member, shown as a reciprocating blade 300, that is configured to be removably coupleable to the drive unit 12 according to an exemplary embodiment. The reciprocating blade 300 includes an elongated body 302 substantially defining a longitudinal axis 304. A secured portion 306 of the reciprocating blade 300 is substantially planar and configured to be received by the drive unit 12 and vertically constrained between the cover 56 and the support surface 54. A work-engaging portion 308 of the reciprocating blade 300, substantially opposite the secured portion 306, is used to perform and/or facilitate a task (here, cutting) by engaging with an element to be operated (e.g., worked, etc.) on by the multi-functional tool 10.

Referring to FIG. 8, an arrangement of coupling features, shown as an arrangement of apertures 310, is located at the secured portion 306 of the reciprocating blade 300 according to an exemplary embodiment. The arrangement of apertures 310 is configured to cause reciprocal movement of the reciprocating blade 300 when used with the drive unit 12. The arrangement of apertures 310 is shown including a first aperture, configured as a first slot 312 extending in a direction along or parallel to the longitudinal axis 304, and a second aperture, configured as a second slot 314 that extends generally transverse to the longitudinal axis 304. The first slot 312 and the second slot 314 are spaced along the longitudinal axis 304. The first slot 312 is shown disposed between a front portion 316 and a rear portion 318 of the elongated body 302. The second slot 314 is also shown disposed between the front portion 316 and the rear portion 318 of the elongated body 302, but is disposed closer to the rear portion 318 of the elongated body 302 than the first slot 312. At this location, the second slot 314 is distal to the work-engaging portion 308 of the reciprocating blade 300 relative to the first slot 312. Preferably the width of the first slot 312 is slightly larger than the diameter of the first mounting pin 22 and its length is substantially the same as the longitudinal travel distance of the second mounting pin 24. Preferably the width of the second slot 314 is slightly larger than the diameter of the second mounting pin 24 and its length is substantially the same as the latitudinal travel distance of the second mounting pin 24.

Referring further to FIG. 8, coupling the reciprocating blade 300 to the drive unit 12 of the multi-functional tool 10 includes engaging the arrangement of apertures 310 with the drive unit coupling features. The first slot 312 engages the first mounting pin 22 and is configured to allow movement of the elongated body 302 relative to the first mounting pin 22 along or parallel to the longitudinal axis 304 while substantially preventing movement transverse to the longitudinal axis 304 at the first slot 312. The second slot 314 engages the second mounting pin 24 and is configured to allow movement of the second mounting pin 24 relative to the elongated body 302 transverse to the longitudinal axis 304 without causing substantial movement of the second mounting pin 24 relative to the elongated body 302 along or parallel to the longitudinal axis 304 at the second slot 314. Accordingly, as the second mounting pin 24 moves in its orbital path, the front-to-back component of motion of the second mounting pin 24 causes the reciprocating blade 300 to move generally front-to-back along or parallel to the longitudinal axis 304 and relative to the support surface 54. One or more motion restricting elements, shown as inserts 320, may be used to prevent undesired side-to-side movement of the reciprocating blade 300 relative to the support surface 54 and/or the drive unit 12. In this way, the interaction between the pins 22, 24 and the arrangement of apertures 310 causes the work-engaging portion 308 of the reciprocating blade 300 to be moved in a motion relative to the drive unit 12 that is a reciprocating motion, as generally indicated by the arrows in FIG. 8. According to other exemplary embodiments, other motion restricting elements may be utilized that are integral with the drive unit or that are removably coupled thereto. For example, one or more side walls may be slidably movable relative to the support surface in order to prevent undesired side-to-side movement of the reciprocating blade.

The work-engaging portion 308 of the reciprocating blade 300 is shown including a plurality of teeth 322 according to an exemplary embodiment. The teeth 322 are configured to cut into and/or through an element (external to the multi-functional tool) component that is engaged by the reciprocating blade 300. The teeth 322 are shown disposed generally to one side of the work-engaging portion 308, which is shown having a pair of sides 324. The sides 324 are shown tapered, but need not be. According to other exemplary embodiments, the work-engaging portion of the reciprocating-movement operating member may be configured to have any structure or shape suitable for utilizing a reciprocating cutting motion.

According to other exemplary embodiments of a reciprocating-movement operating member, while the work-engaging portion of the reciprocating movement operating member may vary based on the task being performed and/or facilitated, the arrangement of apertures will remain substantially the same. That being said, variations to the individual apertures (e.g., the size, the length, proximity to each other, etc.) may be made/accommodated so long as the interaction between the arrangement of apertures and the drive unit coupling features still provides for achieving reciprocating motion. For example, the distance that one of the slots extends along the longitudinal axis may vary or the apertures may be disposed along a line parallel to the longitudinal axis of the elongated body rather than on the longitudinal axis.

According to an alternative embodiment, one or more of the drive unit coupling features and the coupling features of the reciprocating-movement operating member may be interchanged (e.g., swapped, switched, etc.) so long as the desired motion of the operating member is still achieved. According to one exemplary embodiment, the first drive unit coupling feature is a slot aperture, rather than a pin, and the first coupling feature of the reciprocating-movement operating member is a pin that is configured to be received in the slot. According to other exemplary embodiments, coupling features other than pins and/or apertures may be utilized.

FIG. 9 shows another exemplary embodiment of an orbital-movement operating member, shown as a sanding pad holder 400 including an arrangement of apertures 410. As can be seen in FIG. 9, the arrangement of apertures 410 is substantially similar to the arrangement of apertures 110 of the orbital blade 100. Like the orbital blade 100, the interaction between the pins 22, 24 of the drive unit 12 and the arrangement of apertures 410 causes a work-engaging portion 408 of the sanding pad holder 400 to be moved in a motion relative to the drive unit 12 that is an orbital motion, as generally indicated by the arrows in FIG. 9. In contrast to the orbital blade 110, the work-engaging portion provides for sanding of an element to be operated (e.g., worked, etc.) on by the multi-functional tool 10.

As mentioned above, any number of tasks can be completed by utilizing an operating member having an arrangement of apertures corresponding to the motion desired and a work-engaging portion suitable for performing the desired task. According to some other exemplary embodiments, the work-engaging portion may be suitable for scraping, grinding, percussion-related tasks, or creating vibrations.

Moreover, the motion of the multi-functional tool may be changed by changing the operating member coupled to (e.g., engaged by/with, connected to, etc.) the drive unit. That is, replacing a first operating member having a first plurality of coupling features (e.g., a first arrangement of apertures) that provide for a first motion with a second operating member having a second plurality of coupling features (e.g., a second, different arrangement of apertures) that provide for a second motion, changes the operational motion of the multi-functional tool (e.g., when the second mounting pin is moved relative to the first mounting pin). According to some exemplary embodiments, a third operating member having a third plurality of coupling features (e.g., a third arrangement of apertures different from the first and the second arrangements of apertures) that provide for a third motion may also be provided. Further, this third operating member may also be interchangeable with an operating member coupled to the drive unit (e.g., the first operating member or the second operating member) to change the operational motion of the multi-functional tool. Generally, interchanging operating members involves disengaging the coupling features (e.g., apertures) of one operating member from the drive unit coupling features (e.g., pins), and engaging the coupling features (e.g., apertures) of another operating member with the drive unit coupling features (e.g., pins). The first motion, second motion, and the third motion each correspond to a planar motion that is one of orbital motion, sagittal motion, and reciprocal motion. For example, the first operating member, the second operating member, and the third operating member as discussed in this paragraph may each correspond (in no particular order) to one of the orbital blade 100, the sagittal blade 200, and the reciprocating blade 300 discussed above. As is evident to one reading this disclosure, actually achieving an orbital, sagittal, or reciprocating motion of an operating member involves operating (e.g., turning “on”) the drive unit 12 in order to move the second mounting pin 24 in an orbital path and relative to the first mounting pin 22 once an operating member is secured to the drive unit 12.

According to an exemplary embodiment, a kit-of-parts for the multi-functional tool is provided. The kit-of-parts includes a drive unit having a plurality of drive unit coupling features (e.g., the first mounting pin and the second mounting pin) and one or more operating members. Typically, at least two operating members will be provided, though, more than two operating members is contemplated. The operating members may all be configured for similar tasks (e.g., cutting-type tasks) or may be configured for a variety of different tasks (e.g., one operating member may be configured for cutting and another for sanding). Further, operating members may be acquired and/or utilized independent of the drive unit as described herein. It is contemplated that numerous operating members may be independently acquired to be added to a set of operating members for use with a drive unit.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the constructions and arrangements of the multi-functional tool or components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A kit-of-parts for a multi-functional tool, the kit-of-parts comprising:
a drive unit with a first mounting pin and a second mounting pin movable relative to the first mounting pin;
a first operating member having a first arrangement of first and second apertures, wherein the first and second apertures are configured to engage the first and second pins, respectively, when the first operating member is connected to the drive unit, wherein the first arrangement is configured to cause the first operating member to move in a first motion relative to the drive unit when the second mounting pin is moved relative to the first mounting pin; and
a second operating member having a second arrangement of first and second apertures different from the first arrangement, wherein the first and second apertures are configured to engage the first and second pins, respectively, when the second operating member is connected to the drive unit, wherein the second arrangement is configured to cause the second operating member to move in a second motion relative to the drive unit when the second mounting pin is moved relative to the first mounting pin.

2. The kit-of-parts of claim 1, wherein the second mounting pin is configured to move in an orbital motion while the first mounting pin remains stationary.

3. The kit-of parts of claim 1, wherein the second mounting pin is configured to be distal to a work-engaging portion of one of the first and second operating members when the one of first and second operating members is connected to the drive unit.

4. The kit-of-parts of claim 1, wherein the first motion and the second motion are each one of an orbital motion, a reciprocating motion, and a sagittal motion.

5. The kit-of-parts of claim 1, wherein the first and second apertures, in each of the first and second arrangements, are spaced along a direction of a longitudinal axis of the respective first and second operating member.

6. The kit-of-parts of claim 5, wherein at least one of the first arrangement and the second arrangement includes the first aperture configured as a slot extending in the direction of the longitudinal axis of the respective first and second operating member and the second aperture configured as a slot extending perpendicular to the direction of the longitudinal axis of the respective first and second operating member, such that the respective first and second motion is a reciprocating motion.

7. The kit-of-parts of claim 5, wherein at least one of the first arrangement and the second arrangement includes the first aperture configured as a circular aperture and the second aperture configured as a slot extending in the direction of the longitudinal axis of the respective first and second operating member, such that the respective first and second motion is a sagittal motion.

8. The kit-of-parts of claim 5, wherein at least one of the first arrangement and the second arrangement includes the first aperture configured as a slot extending in a direction along or parallel to the longitudinal axis of the respective first and second operating member and the second aperture configured as a circular aperture, such that the respective first and second motion is an orbital motion.

9. The kit-of-parts of claim 1, further comprising a third operating member having a third arrangement of first and second apertures different from the first and second arrangements, wherein the first and second apertures are configured to engage the first and second pins, respectively, when the third operating member is connected to the drive unit, wherein the third arrangement is configured to cause the third operating member to move in a third motion relative to the drive unit when the second mounting pin is moved relative to the first mounting pin.

10. The kit-of-parts of claim 9, wherein the third arrangement includes one of the first aperture configured as a slot extending in a direction of a longitudinal axis of the third operating member and the second aperture configured as circle, such that the third motion is an orbital motion;
the first aperture configured as a slot extending in the direction of the longitudinal axis of the third operating member and the second aperture configured as a slot extending perpendicular to the direction of the longitudinal axis of the third operating member, such that the third motion is a reciprocating motion; and
the first aperture configured as a circle and the second aperture configured as a slot extending in the direction of the longitudinal axis of the third operating member, such that the third motion is a sagittal motion.

11. A method for changing the motion of a multi-functional tool, comprising:
connecting a first operating member having a first arrangement of first and second apertures to a drive unit having a first mounting pin and a second mounting pin by engaging the first and second apertures with the first and second mounting pins, respectively;
moving the second mounting pin relative to the first mounting pin to cause the first operating member to move in a first motion relative to the drive unit;
removing the first operating member from the drive unit;
connecting a second operating member having a second arrangement of first and second apertures, different from the first arrangement, to the drive unit by engaging the first and second apertures with the first and second mounting pins, respectively; and
moving the second mounting pin relative to the first mounting pin to cause the second operating member to move in a second motion relative to the drive unit.

12. The method of claim 11, further comprising the steps of:
removing the second operating member from the drive unit;
connecting a third operating member having a third arrangement of first and second apertures, different from the first and second arrangements, to the drive unit by engaging the first and second apertures with the first and second mounting pins, respectively; and
moving the second mounting pin relative to the first mounting pin to cause the third operating member to move in a third motion.

13. The method of claim 11, wherein the second mounting pin is moved in an orbital path while the first mounting pin remains stationary.

14. The method of claim 11, wherein the first and second apertures of the first operating member are configured to one of restrict the first motion in a direction along a longitudinal axis of the first operating member, restrict the first motion in a direction in which the longitudinal axis or an axis parallel to the longitudinal axis of the first operating member pivots, and restricts the first motion along a circular or elliptical path.

15. A drive unit providing adjustable stroke distances for a work-engaging portion of an operating member, the drive unit comprising:
a drive shaft rotatable about a drive shaft axis;
a motor configured to drive the drive shaft;
a first drive unit coupling feature defining a first axis;
a second drive unit coupling feature defining a second axis and being configured to be driven in an orbital path about the drive shaft axis upon rotation of the drive shaft; and
an offset mechanism configured to change the orbital path of the second drive unit coupling feature about the drive shaft axis and thereby change a stroke distance of a work-engaging portion of an operating member coupled to the first drive unit coupling feature and the second drive unit coupling feature.

16. The drive unit of claim 15, wherein the first drive unit coupling feature includes a first pin for engaging the operating member and the second drive unit coupling feature includes a second pin for engaging the operating member.

17. The drive unit of claim 16, wherein at least one of an outer surface of the first pin and an outer surface of the second pin is rotatably movable about a respective axis of the first pin and the second pin to reduce wear to an operating member.

18. The drive unit of claim 15, wherein the offset mechanism includes at least a first bore that provides a first predetermined offset of the second drive unit coupling feature relative to the drive shaft axis, and a second bore that provides a second predetermined offset of the second drive unit coupling feature relative to the drive shaft axis.

19. The drive unit of claim 15, further comprising a housing with a support surface configured to at least partially support the operating member, the location of the first axis relative to the support surface being fixed.

20. The drive unit of claim 19, wherein the housing includes a cover configured to at least partially confine a portion of the operating member between the support surface and the cover.

21. The drive unit of claim 15, further comprising a first operating member configured to removably engage the first and second drive unit coupling features and to move in a first motion relative to the drive unit when the second drive unit coupling feature is driven in the orbital path, and a second operating member configured to removably engage the first and second drive unit coupling features and to move in a second motion relative to the drive unit when the second drive unit coupling feature is driven in the orbital path, wherein the second motion is different from the first motion.

22. A sagittal-movement operating member removably coupleable to a drive unit, the sagittal-movement operating member comprising:
an elongated body extending substantially along a longitudinal axis and including a front portion opposite a rear portion along the longitudinal axis;
a first coupling feature disposed between the front portion and the rear portion of the elongated body and configured to engage a corresponding first drive unit coupling feature to substantially prevent movement of the elongated body relative to the first drive unit coupling feature along and transverse to the longitudinal axis at the first coupling feature; and
a second coupling feature disposed between the front portion and the rear portion of the elongated body and closer to the rear portion of the elongated body relative to the first coupling feature, the second coupling feature being configured to engage a corresponding second drive unit coupling feature to allow movement of the second drive unit coupling feature relative to the elongated body one of along or parallel to the longitudinal axis without causing substantial movement of the second drive unit coupling feature relative to the elongated body transverse to the longitudinal axis at the second coupling feature.

23. The sagittal-movement operating member of claim 22, wherein the second coupling feature includes a slot extending one of along and parallel to the longitudinal axis.

24. The sagittal-movement operating member of claim 22, wherein the elongated body is configured to pivot about the first coupling feature.

25. The sagittal-movement operating member of claim 24, wherein the first coupling feature is substantially circular and a pin.

26. A reciprocating-movement operating member removably coupleable to a drive unit, the reciprocating-movement operating member comprising:
an elongated body extending substantially along a longitudinal axis and including a front portion opposite a rear portion along the longitudinal axis;
a first coupling feature being disposed between the front portion and the rear portion of the elongated body and configured to engage a corresponding first drive unit coupling feature to allow movement of the elongated body relative to the first drive unit coupling feature one of along or parallel to the longitudinal axis while substantially preventing movement transverse to the longitudinal axis at the first coupling feature; and
a second coupling feature being disposed between the front portion and the rear portion of the elongated body and closer to the rear portion of the elongated body relative to the first coupling feature, the second coupling feature being configured to engage a corresponding second drive unit coupling feature to allow movement of the second drive unit coupling feature relative to the elongated body transverse to the longitudinal axis without causing substantial movement of the second drive unit coupling feature relative to the elongated body along or parallel to the longitudinal axis at the second coupling feature.

27. The reciprocating-movement operating member of claim 26, wherein the first coupling feature includes a slot extending one of along or parallel to the longitudinal axis.

28. The reciprocating-movement operating member of claim 26, wherein the second coupling feature includes a slot extending generally perpendicular to the longitudinal axis.
